(19) United States
(12) Patent Application Publication
(10) Pub. No.: US 2024/0377584 A1
(43) Pub. Date: Nov. 14, 2024

(54) OPTICAL DEVICE AND OPTICAL RECEIVER

(71) Applicant: FUJITSU OPTICAL COMPONENTS LIMITED, Kawasaki-shi (JP)

(72) Inventor: Akira OKA, Kawasaki (JP)

(73) Assignee: FUJITSU OPTICAL COMPONENTS LIMITED, Kawasaki-shi (JP)

(21) Appl. No.: 18/630,447

(22) Filed: Apr. 9, 2024

(30) Foreign Application Priority Data
May 12, 2023 (JP) 2023-079086

(51) Int. Cl. G02B 6/122

(52) U.S. Cl. CPC G02B 6/1228

(57) ABSTRACT

An optical device includes an optical waveguide that is constituted of a cladding and a core formed on a substrate. The optical waveguide includes an input waveguide, an attenuator section that is connected to the input waveguide, a removing section that is connected to the attenuator section, and an output waveguide that is connected to the removing section. The attenuator section is configured to have more waveguide modes that are guided on a cross section perpendicular to a traveling direction of light in a connecting portion connected to the removing section compared to a connecting portion connected to the input waveguide. The removing section is configured to have less waveguide modes that are guided on a cross section perpendicular to a traveling direction of light in a connecting portion connected to the output waveguide compared to a connecting portion connected to the attenuator section.

### CROSS-REFERENCE TO RELATED APPLICATION

This application is based upon and claims the benefit of priority of the prior Japanese Patent Application No. 2023-079086, filed on May 12, 2023, the entire contents of which are incorporated herein by reference.

### FIELD

The embodiments discussed herein are related to an optical device and an optical receiver.

### BACKGROUND

In recent years, by using a coherent optical communication technique, high-speed and high-capacity communication in optical fiber networks is enabled. In the optical receiver of the coherent optical communication technique, after a reception light, the optical power of which has attenuated due to long-distance transmission is mixed with a local light generated within the receiver, the mixed reception light is converted into photoelectric current by a photo detector (PD). As a result, the optical receiver enables highly sensitive reception by reducing an influence of thermal noise generated after the PD.

However, in the optical receiver, as the optical power of the local light increases, the reception sensitivity improves, but when a large optical power is input to the PD, the response speed of the PD is limited by the space-charge effect, making high-speed communication difficult.

In the space-charge effect, when light input into the PD generates electron-hole pairs, the electric field generated by these carriers within the PD acts in a direction that cancels an applied bias to the PD, thereby reducing the applied bias, and a force that conveys carriers within the PD to the outside of the PD is decreased. As a result, the response speed of the PD decreases.

Moreover, the space-charge effect becomes significant, when the number of electron-hole pairs generated within the PD is large, in other words, when the input power is large. Therefore, the space-charge effect can be mitigated by reducing the input power.

Accordingly, as a method of reducing the input power to mitigate the space change effect, for example, a method using an optical attenuator has been known. The optical attenuator can reduce an output power compare to an input power by partially attenuating the power of input light.

Moreover, in the coherent optical communication technique, for example, to perform wavelength division multiplexing, the optical attenuator is preferable to be configured such that optical attenuation of guided signal light be stable over a wide wavelength range.

Furthermore, the optical attenuator used within an optical transceiver used for coherent optical communication is preferable to be compact. Therefore, for example, the optical attenuator that achieves miniaturization includes a substrate of silicon-on-insulator (SOI) wafer and a lower cladding formed on a buried oxide (BOX) layer of SiO₂ on the substrate. Furthermore, the optical attenuator includes an optical waveguide that is formed with a core in an arbitrary shape formed by etching Si on the SOI wafer and an upper cladding formed by laminating SiO₂ on the optical waveguide. When such an optical waveguide is formed, silicon photonics technology is adopted.

Therefore, in a compact optical transceiver, for example, to achieve a PD with optical durability, it is important to fabricate an optical attenuator with a substrate-type optical waveguide. As such an optical attenuator, for example, a directional coupler (DC) has been known (for example, H. Yamada, T. Chu, S. Ishida, and Y. Arakawa, “Optical directional coupler based on Si-wire waveguides”, IEEE Photonics Technology Letters, vol. 17, no. 3, pp. 585-587, March 2005).

FIG. 12 is a planar schematic diagram illustrating an example of a conventional directional coupler 100, and FIG. 13 is a substantially cross-sectional schematic diagram cut along a line A-A in FIG. 12. The directional coupler 100 illustrated in FIG. 12 uses two waveguides arranged in parallel, and includes a first waveguide 101 and a second waveguide 102 that is arranged in parallel with the first waveguide 101. The directional coupler 100 illustrated in FIG. 13 includes an SOI substrate not illustrated, a lower cladding 103A on a BOX layer laminated on the SOI substrate, and the first waveguide 101 and the second waveguide 102 formed on the lower cladding 103A. Furthermore, the directional coupler 100 includes a lower cladding 103A, and a upper cladding 103B that is laminated on the first waveguide 101 and the second waveguide 102.

In the directional coupler 100, light input into the first waveguide 101 gradually transitions its optical power to the second waveguide 102 adjacent along a traveling direction of light. That is, the directional coupler 100 can attenuate desired optical power if it is designed such that the parallel section between the first waveguide 101 and the second waveguide 102 ends after the desired transition of optical power has occurred.

In the directional coupler 100, as the length of the parallel section between the first waveguide 101 and the second waveguide 102 increases, transition of optical power between the first waveguide 101 and the second waveguide 102 increases, and after the transition, the optical power returns in the opposite direction. Therefore, the length of the parallel section is adjusted to be able to obtain a desired optical attenuation.

However, in the directional coupler 100, even if it is designed to be able to obtain desired optical attenuation for light of a predetermined wavelength, the optical attenuation varies when wavelengths of light guided through the waveguides differ.

Moreover, in the directional coupler 100, evanescent waves emanating from the core can couple to an adjacent waveguide, to cause optical transition. As the wavelength of the signal light increases, penetration of the evanescent waves increases, and optical coupling to the adjacent waveguide becomes stronger. That is, the attenuation increases as the wavelength of signal light increases. Moreover, as the optical coupling between adjacent waveguides becomes stronger, the length of the parallel section for the optical power to transition for a desired amount of power can be shortened.

FIG. 14 is an explanatory diagram illustrating an example of a correlation between a wavelength of light guided through the directional coupler 100 and a calculation result of an optical attenuation. The optical attenuation of the calculation result is a loss from an optical power output from the directional coupler 100 with respect to an optical power input to the directional coupler 100. The directional coupler 100 used for the calculation of an optical attenuation is designed to achieve a target attenuation of 2.0 dB when a wavelength of a signal light to guide is 1.55 μm. Furthermore, it is designed such that a core width of the first waveguide 101 of the directional coupler 100 is 0.5 μm, a core thickness thereof is 0.22 μm, a core width of the second waveguide 102 is 0.5 μm, a core thickness thereof is 0.22 μm, and an interval between the first waveguide 101 and the second waveguide 102 is 0.2 μm.

For example, there are as reference, Japanese Laid-open Patent Publication Nos. 2012-199373, 2010-151973, 2014-39021, U.S. Patent Application Publication Nos. 2014/0023314, 2013/0051727, A. Beling, X. Xie, and J. C. Cambell, “High-power, high-linearity photodiodes”, Optica, vol. 3, no. 3, pp. 328-338, 2016.

However, as illustrated in FIG. 14, the directional coupler 100 has large wavelength dependence, because the optical attenuation changes significantly when the wavelength of a guided signal light changes. That is, when the wavelength dependence is large, a desired optical attenuation is not achieved per wavelength of a signal light to be used in wavelength division multiplexing, and excessive loss or insufficient attenuation occurs. Therefore, there is a demand for optical attenuators with low wavelength dependence.

### SUMMARY

According to an aspect of an embodiment, an optical device includes an optical waveguide that includes a cladding and a core formed on a substrate. The optical waveguide includes an input waveguide, an attenuator section that is connected to the input waveguide, a removing section that is connected to the attenuator section, and an output waveguide that is connected to the removing section. The attenuator section is configured to have more waveguide modes that are guided on a cross section perpendicular to a traveling direction of light in a connecting portion connected to the removing section compared to a connecting portion connected to the input waveguide. The removing section is configured to have less waveguide modes that are guided on a cross section perpendicular to a traveling direction of light in a connecting portion connected to the output waveguide compared to a connecting portion connected to the attenuator section.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of an optical receiver according to the present embodiment;

FIG. 2 is a block diagram illustrating an example of an optical attenuator according to a first embodiment;

FIG. 3 is a cross-sectional schematic diagram illustrating an example of cores of a tapered waveguide used in an attenuating unit in the optical attenuator and a modeled tapered waveguide;

FIG. 4 is a planar schematic diagram illustrating an example of an optical attenuator according to a second embodiment;

FIG. 5 is a substantially cross-sectional schematic diagram illustrating an example of an optical attenuator;

FIG. 6 is an explanatory diagram illustrating an example of a correlation between a calculation result of an attenuation of the attenuating unit and a core width of a second connecting portion;

FIG. 7 is an explanatory diagram illustrating an example of a correspondence between an attenuation of the attenuating unit and a wavelength of light guided through the attenuating unit;

FIG. 8 is an explanatory diagram illustrating an example of a correspondence between a conversion efficiency to TE2, which is a higher-order mode other than TE0, occurring at a second connecting portion of the attenuating unit and a core width of the second connecting portion of the attenuating unit;

FIG. 9 is an explanatory diagram illustrating an example of a correspondence between a core width of the optical attenuator and a calculation result of an effective refractive index of each waveguide mode of light guided through the core;

FIG. 10 is an explanatory diagram illustrating an example of a correspondence between a core width of the second connecting portion and a calculation result of reflection loss;

FIG. 11 is an explanatory diagram illustrating an example of s symmetric tapered waveguide and an asymmetric tapered waveguide;

FIG. 12 is a planar schematic diagram illustrating an example of a conventional directional coupler;

FIG. 13 is a substantially cross-sectional schematic diagram cut along a line A-A in FIG. 12; and

FIG. 14 is an explanatory diagram illustrating an example of a correspondence between a wavelength of light guided through the directional coupler and a calculation result of an optical attenuation.

### DESCRIPTION OF EMBODIMENTS

Preferred embodiments of the present invention will be explained with reference to accompanying drawings. The embodiments are not intended to limit the disclosed technique. Moreover, the respective embodiments may be combined within a range not causing a contradiction.

### (a) First Embodiment

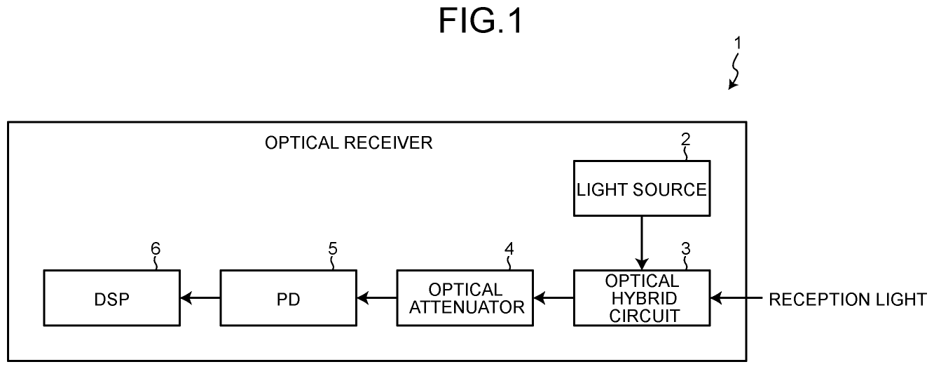

FIG. 1 is a block diagram illustrating an example of an optical receiver 1 according to the present embodiment. The optical receiver 1 illustrated in FIG. 1 includes a light source 2, an optical hybrid circuit 3, an optical attenuator 4, a photo detector (PD) 5, and a digital signal processor (DSP) 6. The light source 2 is, for example, a laser diode (LD) that emits local light. The optical hybrid circuit 3 is an optical demodulator that obtains reception light for each polarization by interfering the local light emitted from the light source 2 with the reception light received from an optical fiber. The optical attenuator 4 attenuates an optical power of the reception light from the optical hybrid circuit 3. The PD 5 performs electric conversion on the reception light subjected to attenuation, to convert into a reception signal. The DSP 6 performs signal processing with respect to the reception signal subjected to the electric conversion.

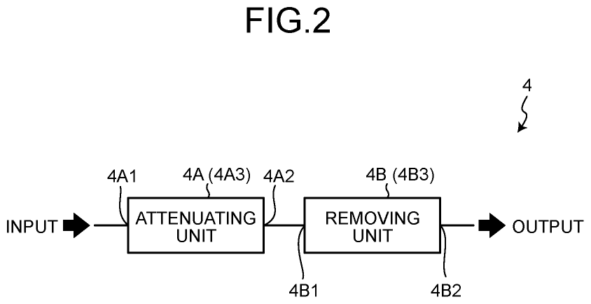

FIG. 2 is a block diagram illustrating an example of the optical attenuator 4. The optical attenuator 4 illustrated in FIG. 2 is an optical device having an attenuating unit 4A and a removing unit 4B. The attenuating unit 4A is a tapered waveguide in which the number of waveguide modes for signal light to be guided on a cross section perpendicular to a traveling direction of light increases. The removing unit 4B is connected to the attenuating unit 4A, and is a tapered waveguide in which the number of waveguide modes for signal light to be guided on a cross section perpendicular to a traveling direction of the signal light from the attenuating unit 4A decreases.

The attenuating unit 4A includes an input unit 4A1, an output unit 4A2, and a tapered waveguide 4A3 between the input unit 4A1 and the output unit 4A2, and has a tapered waveguide structure in which a core width of the tapered waveguide 4A3 continuously varies along a traveling direction of light. The input unit 4A1 is connected to the optical hybrid circuit 3. The output unit 4A2 is connected to the removing unit 4B. The tapered waveguide structure may include a portion in which the core width does not vary, and is appropriately changeable. The number of waveguide modes for guiding on a cross section perpendicular to the traveling direction of light in the output unit 4A2 of the attenuating unit 4A increases compared to the number of waveguide modes for guiding on a cross section perpendicular to the traveling direction of light in the input unit 4A1.

The removing unit 4B includes an input unit 4B1, an output unit 4B2, and a waveguide 4B3 between the input unit 4B1 and the output unit 4B2, and has a tapered waveguide structure in which a core width continuously varies along the traveling direction of light. The tapered waveguide structured may include a portion in which the core width does not vary, and is appropriately changeable. The input unit 4B1 is connected to the attenuating unit 4A. The output unit 4B2 is connected to the PD 5. The number of waveguide modes for guiding on a cross section perpendicular to the traveling direction of light in the output unit 4B2 of the removing unit 4B decreases compared to the number of waveguide modes on a cross section perpendicular to the traveling direction of light in the input unit 4B1.

In the tapered waveguide structure, the number of waveguide modes for guiding on one cross section increases as the size of a core increases. That is, the attenuating unit 4A has a tapered structure in which the core size of the output unit 4A2 is large compared to the core size of the input unit 4A1, to increase the number of waveguide modes for signal light on a cross section of the output unit 4A2 compared to the number of waveguide modes for signal light on a cross section of the input unit 4A1.

Furthermore, in the tapered waveguide structure, the ratio of optical power transitioning to a mode different from an input mode increases as the cores size of the output unit 4A2 increases. When this rate increases, the input mode attenuates according to the rate of the optical power that transitions. That is, in the attenuating unit 4A, transition to another mode can be performed efficiently because the number of waveguide modes increases in the output unit 4A2 compared to the input unit 4A1.

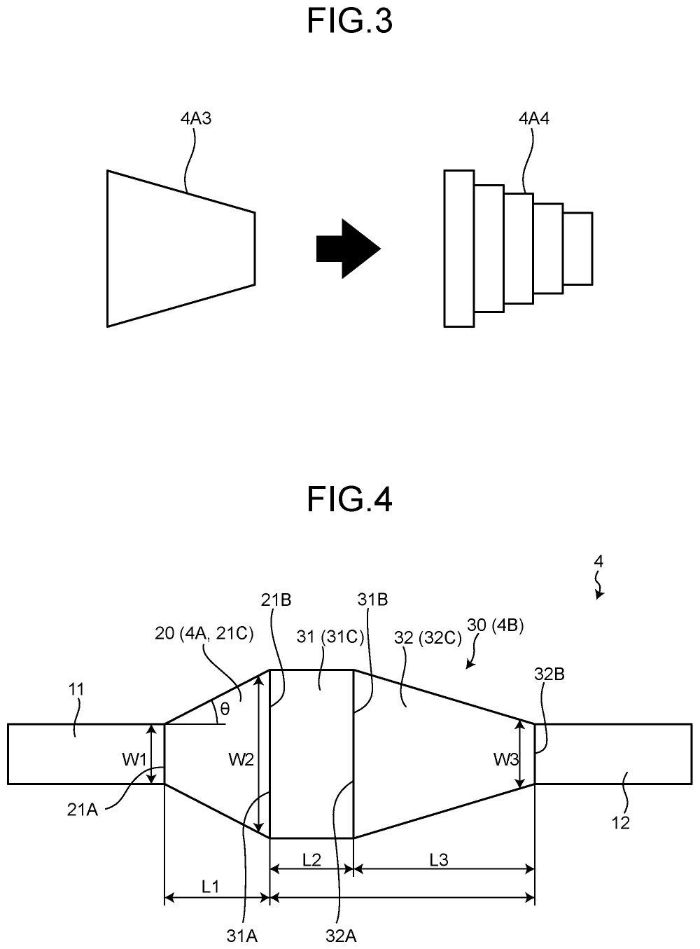

Furthermore, the transition of the optical power to a different mode in the tapered waveguide has low wavelength dependence. FIG. 3 is a cross-sectional schematic diagram illustrating an example of cores of the tapered waveguide 4A3 used in the attenuating unit 4A and a modeled tapered waveguide 4A4. The tapered waveguide 4A3 can be modeled into the tapered waveguide 4A4 in a stepped shape by connecting waveguides with discontinuous core widths as illustrated in FIG. 3.

When the length of each step in the tapered waveguide 4A4 in a stepped shape illustrated in FIG. 3 is arranged to be sufficiently small, by calculating an overlap integral between an electric field of the mode propagating in the cross-section of each step and an electric field of the mode propagating in the cross-section of a next step, a transition efficiency of the discontinuous waveguides of respective steps can be calculated. That is, the entire efficiency can be obtained based on an integration value of a cross section of each step.

A case in which the wavelength of signal light guided in the tapered waveguide becomes large is considered. The electric field distribution of a mode propagating in the cross section of each step spreads into the cladding, resembling emanation, when the wavelength of signal light being guided is large, but because it similarly varies on the cross section of each step, the values of the overlap integral between the discontinuous cross sections of the respective steps does not change significantly. Similarly, also when the wavelength of signal light becomes short, the value of the overlap integral between the discontinuous cross sections does not change significantly, either. Therefore, in the attenuating unit 4A in which the tapered waveguide structure is adopted, stable optical attenuation can be achieved over a wide wavelength band.

In the attenuating unit 4A, an attenuated optical power transitions to a different mode. However, if an optical power remains in the different mode as it transitions, and is guided to be input to another device, it is also conceivable that it converts into the same mode as the mode input to the attenuating unit 4A. If interreference with the original mode occurs as a consequence, the optical power fluctuates with the wavelength, therefore becoming unstable.

Accordingly, the removing unit 4B removes a different and unwanted mode that has occurred in the attenuating unit 4A, to thereby reduce an influence of the interference to the original mode. Moreover, in the removing unit 4B, the number of waveguide mode on the cross section of the output unit 4B2 can be reduced compared to the number of waveguide mode on the cross section of the input unit 4B1. That is, in the removing unit 4B, by making the size of a core of the output unit 4B2 small compared to the input unit 4B1, an unwanted mode is removed by reducing confinement of light to a core of the unwanted mode to which it has transitioned through attenuation.

As described, in the optical attenuator 4, because the attenuating unit 4A and the removing unit 4B are provided, stable optical attenuation can be achieved over a wide wavelength band.

### (b) Second Embodiment

FIG. 4 is a planar schematic diagram illustrating an example of the optical attenuator 4 according to a second embodiment. For convenience of explanation, the optical attenuator 4 illustrated in FIG. 4 is constituted of a rib optical waveguide 51, but only a core 51A is illustrated and a slab 51B is omitted in illustration. The optical attenuator 4 includes the rib optical waveguide 51 constituted of a cladding 52 and the core 51A formed on a substrate. The rib optical waveguide 51 includes an input waveguide 11, an attenuating unit 20 (4A) that is connected to the input waveguide 11, a removing unit 30 (4B) that is connected to the attenuating unit 20, and an output waveguide 12 that is connected to the removing unit 30 (4B).

The input waveguide 11 is a waveguide that is connected to the optical hybrid circuit 3. The attenuating unit 20 is connected to the input waveguide 11, and is a tapered waveguide connected to the removing unit 30. The removing unit 30 is connected to the attenuating unit 20, and is a tapered waveguide connected to the output waveguide 12. The output waveguide 12 is a waveguide connected to the PD 5.

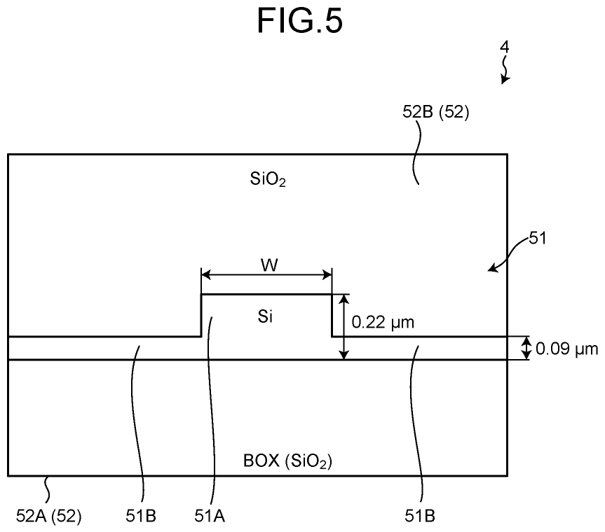

The input waveguide 11, the attenuating unit 20, the removing unit 30, and the output waveguide 12 form the rib optical waveguide 51 with a uniform thickness. FIG. 5 is a cross-sectional schematic diagram illustrating an example of the optical attenuator 4. The optical attenuator 4 illustrated in FIG. 5 includes a substrate not illustrated, a lower cladding 52A on an SiO₂ BOX layer laminated on the substrate, and the rib optical waveguide 51 laminated on the lower cladding 52A, and an upper cladding 52B that is laminated on the rib optical waveguide 51. The rib optical waveguide 51 includes the core 51A and the slab 51B formed on both sides of the core 51A. For convenience of explanation, a width of the core 51A is w, a thickness of the core 51A is 0.22 μm, a thickness of the slab 51B is 0.09 μm.

The input waveguide 11 is, for example, a straight waveguide with the core width of W1. The attenuating unit 20 includes a first connecting portion 21A that is connected to the input waveguide 11, a second connecting portion 21B that is connected to the removing unit 30, and a first tapered waveguide 21C that connects between the first connecting portion 21A and the second connecting portion 21B. The first tapered waveguide 21C is arranged such that the core width of the first connecting portion 21A is W1 and the core width of the second connecting portion 21B is W2, and has a tapered structure in which the core width gradually increases from the first connecting portion 21A to the second connecting portion 21B. A length of the first tapered waveguide 21C of the attenuating unit 20 is L1. The attenuating unit 20 has more waveguide modes guided on a cross section perpendicular to a traveling direction of light in the second connecting portion 21B connected to the removing unit 30 compared to the first connecting portion 21A connected to the input waveguide 11.

The removing unit 30 includes a straight waveguide 31 that is connected to the attenuating unit 20, and a tapered waveguide 32 that is connected to the output waveguide 12. The straight waveguide 31 includes a third connecting portion 31A connected to the second connecting portion 21B of the attenuating unit 20, a fourth connecting portion 31B connected to the tapered waveguide 32, and a waveguide 31C connecting the third connecting portion 31A and the fourth connecting portion 31B, and a core width of the waveguide 31C is W2. A length of the straight waveguide 31 is L2.

The tapered waveguide 32 includes a fifth connecting portion 32A that is connected to the fourth connecting portion 31B of the straight waveguide 31, a sixth connecting portion 32B that is connected to the output waveguide 12, and a second tapered waveguide 32C that connects the fifth connecting portion 32A and the sixth connecting portion 32B. The second tapered waveguide 32C is configured such that a core width of the fifth connecting portion 32A is W2, a core width of the sixth connecting portion 32B is W3, and has a tapered structure in which the core width gradually decreases from the fifth connection portion 32A to the sixth connecting portion 32B. A length of the tapered waveguide 32 is L3. A length of the removing unit 30 is L2+L3. The removing unit 30 has less waveguide modes guided on a cross section perpendicular to a traveling direction of light in the sixth connecting portion 32B that is connected to the output waveguide 12, compared to the third connecting portion 31A of the attenuating unit 20.

In the optical attenuator 4, a case in which TE0 is input from the input waveguide 11 is assumed. TE0 has the highest effective refractive index among waveguide modes (TE modes) that have horizontal electric field components on the substrate. A relationship between a taper angle θ of the attenuating unit 20 and the length L1 of the attenuating unit 20 is L1=(W1−W2)/(2 tan θ).

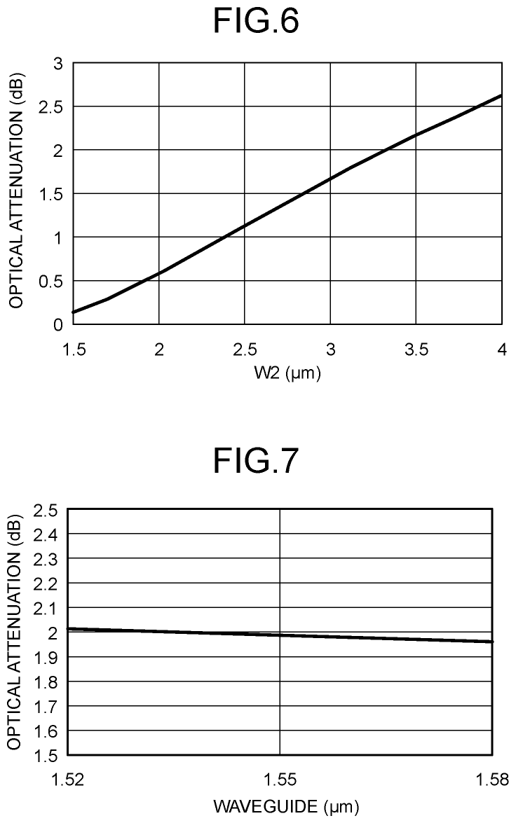

Next, an effect of the attenuating unit 20 will be explained. FIG. 6 is an explanatory diagram illustrating an example of a correlation between a calculation result of attenuation of the attenuating unit 20 and the core width W2 of the second connecting portion 21B. For convenience of explanation, the core width of the first connecting portion 21A W1=1.2 μm, the length of the attenuating unit 20 L1=7 μm, the tapered angle θ=70 degrees, and a wavelength of light guided through the attenuating unit 20 is 1.55 μm. FIG. 6 provides a result obtained by calculating attenuation of TE0of the attenuating unit 20 by the finite difference time domain (FDTD) method when the core width W2 of the second connecting portion 21B is varied. The attenuation is obtained by expressing a ratio of the output optical intensity of TE0 to the input optical intensity of TE0 in decibels (dB) and by adding a negative sign. As a result, by changing the core width W2 of the second connecting portion 21B of the attenuating unit 20, desired attenuation can be adjusted.

When the variation of the core width is abrupt, for example, when the taper angle θ is large, some of the power of TE0 converts into another waveguide mode or a radiation mode and, therefore, attenuation occurs. Furthermore, in the attenuating unit 20, when the variation in the core width of the taper increases, a mismatch between the electric field distribution of TE0 on the cross section of the first connecting portion 21A and the electric field distribution of TE0 on the cross-section of the second connecting portion 21B increases and, therefore, the optical loss increases. Accordingly, desired attenuation can be obtained in the attenuating unit 20.

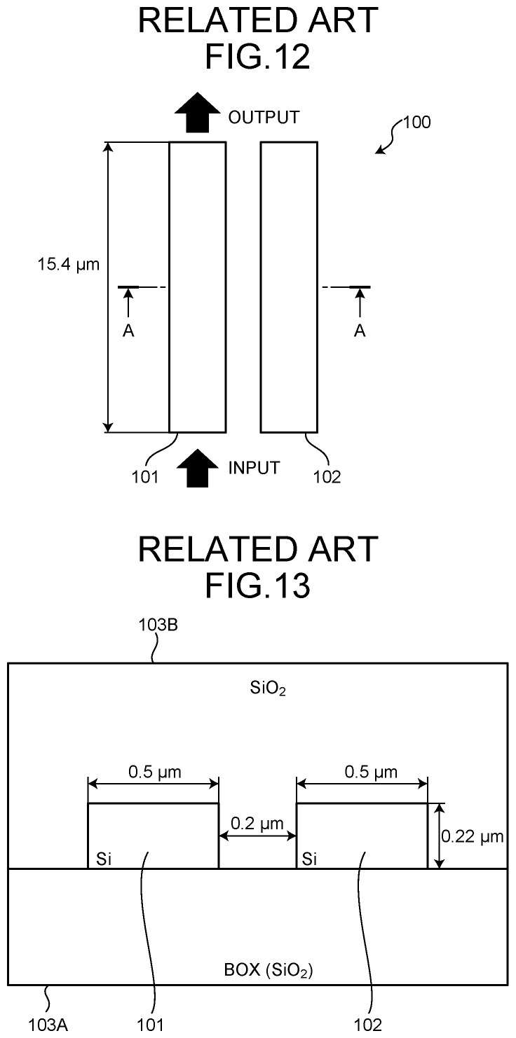

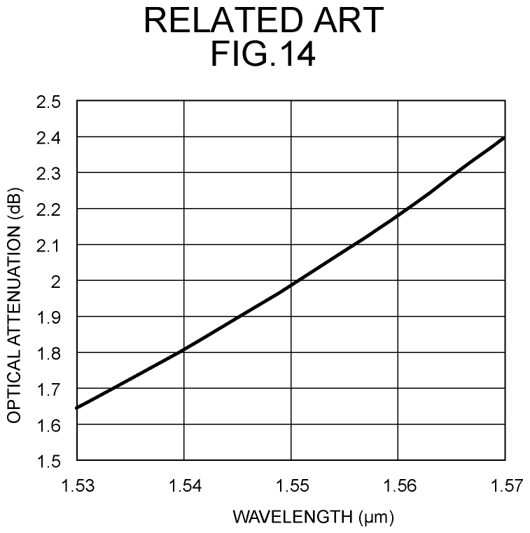

FIG. 7 is an explanatory diagram illustrating an example of a correlation between attenuation of the attenuating unit 20 and a wavelength of light guided through the attenuating unit 20. For convenience of explanation, target attenuation of the attenuating unit 20 is 2 dB, and the core width of the second connecting portion 21B of the attenuating unit 20 is W2=3.2 μm. In this setup environment, the attenuation of each wavelength is calculated. When referring to FIG. 7, the attenuation falls within a range of 1.98 dB to 2.01 dB over a wide wavelength range of 1.52 μm to 1.58 μm. Therefore, it is understood that the wavelength dependency of the attenuating unit 20 is significantly small. In the directional coupler 100 illustrated in FIG. 12, attenuation significantly vary in a range of 1.65 dB to 2.40 dB in a wavelength range of 1.53 μm to 1.57 μm.

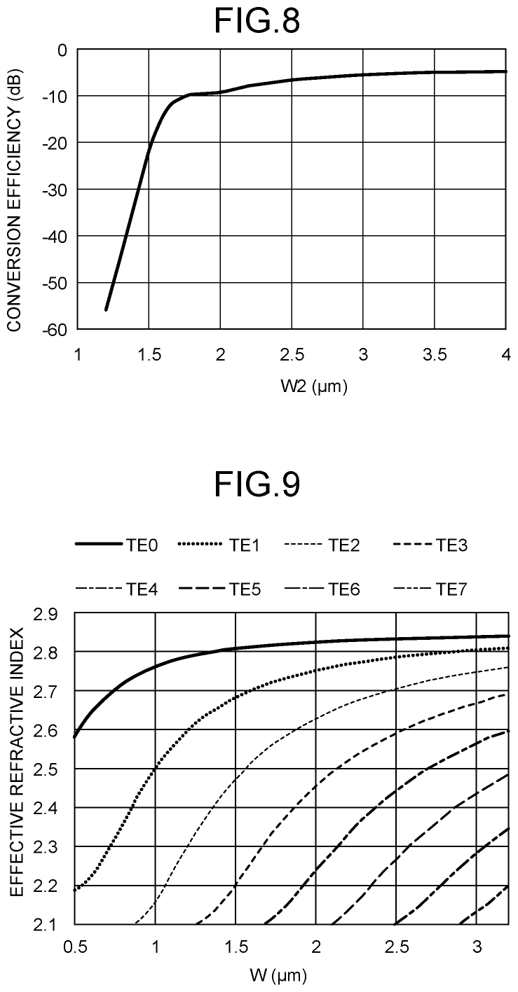

FIG. 8 is an explanatory diagram illustrating an example of a correspondence between a conversion efficiency into TE2, which is a higher-order mode other than TE0 occurring in the second connecting portion 21B of the attenuating unit 20 and the core width W2 of the second connecting portion 21B of the attenuating unit 20. TE2 is a waveguide mode having the third largest effective refractive index among TE modes.

Referring to FIG. 8, it is found that in the attenuating unit 20, the conversion efficiency to TE2 increases as attenuation increases by widening the core width W2 of the second connecting portion 21B. This phenomenon occurs because some of the optical power lost from TE0 is transitioning to TE2. If such an unwanted mode which is a waveguide mode not used for input is converted again back to the original mode same as the input in the optical attenuator 4 and in subsequent stages, the unwanted mode of the input and the same original mode interfere with each other, causing power instability.

The removing unit 30 has a waveguide structure in which an unwanted waveguide mode occurred in the attenuating unit 20 is not guided, and this enables to remove the unwanted mode. As for the unwanted mode, because a higher-order mode than an input mode can become an unwanted mode, the number of waveguide modes of the sixth connecting portion 32B of the removing unit 30 can be reduced compared to the number of waveguide modes of the third connecting portion 31A (same as the second connecting portion 21B of the attenuating unit 20).

For convenience of explanation, target attenuation of the optical attenuator 4 is 2 dB, the core width of the second connecting portion 21B of the attenuating unit 20 is W2=3.2 μm, and the core width of the third connecting portion 31A of the straight waveguide 31 of the removing unit 30 is W2=3.2 μm. The core width of the sixth connecting portion 32B of the tapered waveguide 32 in the removing unit is W3=0.5 μm, the length of the straight waveguide 31 is L2=1 μm, and the length of the tapered waveguide 32 is L3=77.34 μm (it corresponds to, for example, 1.0 degree as the taper angle θ).

The tapered waveguide 32 in the removing unit 30 can ignore a loss of the waveguide mode when the taper angle θ is gentler. In this structure of the optical attenuator 4, for example, in a wavelength range of 1.52 μm to 1.58 μm, the loss is 0.01 dB or less, and it is so small that it can be ignored.

The unwanted waveguide mode of the removing unit 30 will be explained focusing on TE2. The number of waveguide modes decreases as the core width becomes narrow. FIG. 9 is an explanatory diagram illustrating an example of a correlation between a core width of the optical attenuator 4 and a calculation result of an effective refractive index of each waveguide mode of light guided through the core 51A. The thickness of the slab 51B is 0.09 μm, the thickness of the core 51A is 0.22 μm, and the wavelength of light guided through the core 51A is 1.55 μm.

In the optical attenuator 4, the core width varies along a traveling direction of light, and it is found, by referring to FIG. 9, that the number of waveguide modes guided through the core 51A decreases as the core width w becomes narrower.

For example, it is found that while TE2 is guided when the core width of the second connecting portion 21B (the third connecting portion 31A) is W2=3.2 μm, TE2 is not guided when the core width of the sixth connecting portion 32B is W3=0.5 μm. As a result, it is found that an unwanted mode, such as TE2, can be removed on the cross section of the sixth connecting portion 32B of the removing unit 30. The condition under which TE2 is not guided is chosen for convenience of explanation, but losses increase due to roughness on a side wall or the like of the core 51A just by reducing the number of waveguide mode and, therefore, it becomes possible to remove TE2 substantially.

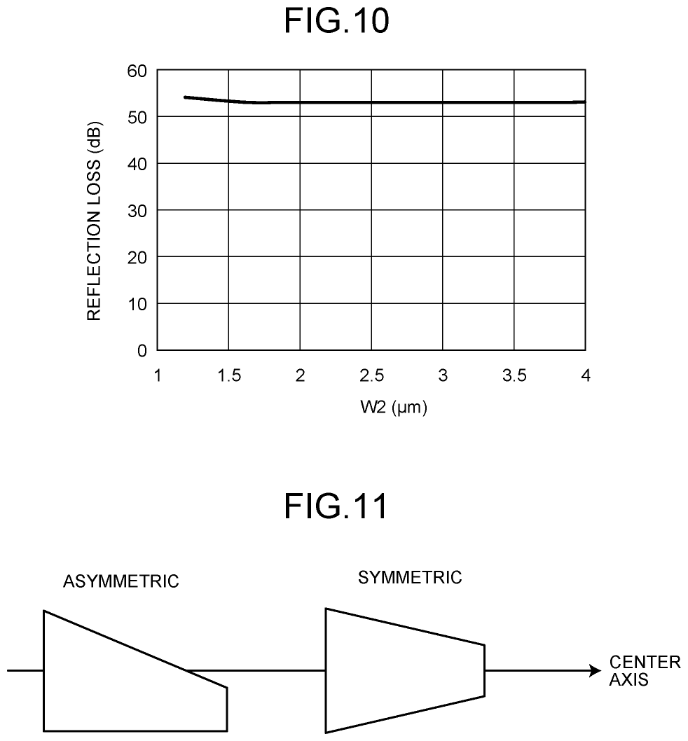

Because the optical attenuator 4 according to the present embodiment has a large taper angle θ, there is a possibility that influence of optical reflection occurs. Therefore, a reflection loss of optical reflection was calculated. The reflection loss is obtained by expressing a ratio of an input optical intensity to an optical intensity output from the input side to the opposite direction in dB and by adding a negative sign. FIG. 10 is an explanatory diagram illustrating an example of a correlation between the core width of the second connecting portion 21B and a calculation result of the reflection loss. Referring to FIG. 10, it is found that even when the core width of the second connecting portion 21B is varied, a reflection loss is 50 dB or more, and that only significantly small reflection occurs. The reason why the reflection loss is small is because the tapered waveguide causes optical attenuation.

The attenuating unit 20 of the optical attenuator 4 is configured such that the number of waveguide modes that are guided on a cross section perpendicular to a traveling direction of light in the second connecting portion 21B connected to the removing unit 30 is large compared to the first connecting portion 21A connected to the input waveguide 11. Furthermore, the removing unit 30 is configured such that the number of waveguide modes that are guided on a cross section perpendicular to a traveling direction of light in the sixth connecting portion 32B connected to the output waveguide 12 is small compared to the third connecting portion 31A of the attenuating unit 20. As a result, by using the attenuating unit 20, stable optical attenuation can be achieved over a wide wavelength band. Furthermore, by using the removing unit 30, an unwanted mode occurring in the attenuating unit 20 can be removed.

The attenuating unit 20 has the first tapered waveguide 21C in which the core width increases as it approaches the removing unit 30 from the input waveguide 11, and the removing unit 30 has the second tapered waveguide 32C in which the core width decreases as it approaches the output waveguide 12 from the attenuating unit 20. As a result, by using the attenuating unit 20, stable optical attenuation can be achieved over a wide wavelength band. Furthermore, by using the removing unit 30, an unwanted mode occurring in the attenuating unit 20 can be removed.

The removing unit 30 has the straight waveguide 31 that is connected to the first tapered waveguide 21C, and the second tapered waveguide 32C that is connected to the straight waveguide 31. As a result, the number of waveguide modes increases by passing through the first tapered waveguide 21C of the attenuating unit 20, and by inputting the respective modes after stabilizing them once with the straight waveguide 31 into the second tapered waveguide 32C of the removing unit 30, it is possible to stabilize the operation. Moreover, in the first tapered waveguide 21C, light converted into the radiation mode can be radiated in the straight waveguide 31. As a result, the radiation mode can suppress coupling to the waveguide mode in the second tapered waveguide 32C, and fluctuations in optical signal power caused by interference with signal light or the like can be reduced, and stabilization can be achieved. The length of the straight waveguide 31 is preferable to be longer than one wavelength.

The optical receiver 1 further includes the PD 5 connected to the output waveguide 12 in the optical attenuator 4. As a result, the space-charge effect is mitigated, to achieve high-speed communication.

It is constituted of waveguides having a uniform thickness in the cores of the input waveguide 11, the attenuating unit 20, the removing unit 30, and the output waveguide 12 in the optical attenuator 4. As a result, manufacturing of the optical attenuator 4 becomes easy.

Although a case in which the optical attenuator 4 according to the present embodiment is formed with the rib optical waveguide 51 has been explained as an example, it is not limited thereto. Instead of the rib optical waveguide 51, a rectangular waveguide, a high-mesa waveguide, or a ridge waveguide may be used, and it can be modified as appropriate. In the case of the rib optical waveguide 51, because light also leaks into a slab portion, the core is less affected by roughness of a side wall, and low-loss propagation is possible. Moreover, because the rectangular waveguide exerts strong light confinement, losses can be maintained low even if a bending radius R is small.

The waveguides of the optical attenuator 4 may be a PLC in which the core 51A and the cladding 52 are both SiO₂, an InP waveguide, or a GaAs waveguide. It may also be an Si waveguide in which the lower cladding 52A is SiO₂, the upper cladding 52B is SiO₂, air, SiN, or the like. When the waveguide is the Si waveguide, because the relative refractive index difference is large, confinement of light is strong, and a bent waveguide with low losses can be thereby achieved even with the small bending radius R. That is, it is preferable for miniaturization of optical devices.

FIG. 11 is an explanatory diagram illustrating an example of a symmetric tapered waveguide and an asymmetric tapered waveguide. The tapered waveguide used for the attenuating unit 20 and the removing unit 30 of the first embodiment has a symmetric structure with respect to a cross section along a traveling direction of light, and an arbitrary axis along the traveling direction of light is to be a symmetry axis. The core of the tapered waveguide is a symmetric tapered waveguide symmetric along the symmetry axis. On the other hand, the tapered waveguide structure has an asymmetric structure with respect to a cross section along the traveling direction of light, and it may be an asymmetric tapered waveguide in which an arbitrary axis along the traveling direction of light is asymmetric. Because the optical receiver 1 has a structure in which the PD 5 is connected in a subsequent stage to the removing unit 30 in the optical attenuator 4, an influence of the space-charge effect is reduced, and high speed communication by the PD 5 in a wide band is enabled.

According to one aspect, stable optical attenuation can be achieved over a wide wavelength band.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical device comprising:
an optical waveguide that includes a cladding and a core formed on a substrate, wherein
the optical waveguide includes
an input waveguide;
an attenuator section that is connected to the input waveguide;
a removing section that is connected to the attenuator section; and
an output waveguide that is connected to the removing section, wherein
the attenuator section is configured to have more waveguide modes that are guided on a cross section perpendicular to a traveling direction of light in a connecting portion connected to the removing section compared to a connecting portion connected to the input waveguide, and
the removing section is configured to have less waveguide modes that are guided on a cross section perpendicular to a traveling direction of light in a connecting portion connected to the output waveguide compared to a connecting portion connected to the attenuator section.

2. The optical device according to claim 1, wherein
the attenuator section includes a first tapered waveguide in which a core width becomes wider toward the removing section from the input waveguide, and
the removing section includes a second tapered waveguide in which a core width becomes narrower toward the output waveguide from the attenuator section.

3. The optical device according to claim 2, wherein
the removing section includes
a straight waveguide that is connected to the first tapered waveguide; and
a second tapered waveguide that is connected to the straight waveguide.

4. The optical device according to claim 1, wherein
the core is formed with a material including silicon, and
the cladding is formed with a material including SiO₂.

5. The optical device according to claim 1, further including a light receiver that is connected to the output waveguide.

6. The optical device according to claim 1, wherein the optical waveguide is constituted of waveguides having a uniform thickness in cores of the input waveguide, the attenuator section, the removing section, and the output waveguide.

7. The optical device according to claim 1, wherein the optical waveguide is constituted of a rib waveguide.

8. An optical receiver comprising:
a light source that emits light;
an optical demodulator that demodulates reception light using the light from the light source;
an optical attenuator section that attenuates the reception light demodulated by the optical demodulator; and
a light receiver that performs electric conversion on the reception light attenuated by the optical attenuator section, wherein
the optical attenuator section includes an optical waveguide constituted of a cladding and a core that are formed on a substrate,
the optical waveguide includes
an input waveguide;
an attenuator section that is connected to the input waveguide;
a removing section that is connected to the attenuator section; and
an output waveguide that is connected to the removing section, wherein
the attenuator section is configured to have more waveguide modes that are guided on a cross section perpendicular to a traveling direction of light in a connecting portion connected to the removing section compared to a connecting portion connected to the input waveguide, and
the removing section is configured to have less waveguide modes that are guided on a cross section perpendicular to a traveling direction of light in a connecting portion connected to the output waveguide compared to a connecting portion connected to the attenuator section.
